(19) United States
(12) Patent Application Publication
(10) Pub. No.: US 2026/0302810 A1
(43) Pub. Date: Oct. 1, 2026

(54) ELECTRONIC DEVICE, CONTROL METHOD THEREFOR, AND PROGRAM

(71) Applicants: Sony Interactive Entertainment Inc., Tokyo (JP); Sony Group Corporation, Tokyo (JP)

(72) Inventors: Yozo Goto, Tokyo (JP); Kosuke Suzuki, Tokyo (JP)

(21) Appl. No.: 19/474,987

(22) PCT Filed: Apr. 18, 2023
(86) PCT No.: PCT/JP2023/015486

§ 371 Date: Oct. 13, 2025

(51) Int. Cl. H02J 7/70; G06F 3/01; H02J 7/80; H02J 50/90

(52) U.S. Cl. CPC H02J 7/731; G06F 3/011; H02J 7/80; H02J 50/90

(57) ABSTRACT

Disclosed is an electronic device that monitors the charging status of a rechargeable battery built into the electronic device, estimates a user's intention of charging according to the status of the electronic device, and when the rechargeable battery is not being charged in a state where it is estimated that the user has the intention of charging, notifies the user of such a fact.

### TECHNICAL FIELD

The present invention relates to an electronic device configured to operate on a built-in rechargeable battery, a control method therefor, and a control program thereof.

### BACKGROUND ART

There are various electronic devices, such as smartwatches, that have built-in rechargeable batteries and operate on power supplied from the built-in rechargeable batteries. In recent years, technologies such as wireless charging technology have been proposed as technologies for easily charging such rechargeable batteries while they are still built into the electronic devices. The above-mentioned technologies enable users to charge an electronic device without any hassle just by performing simple tasks such as placing the electronic device on a charging stand.

### SUMMARY

### Technical Problem

The above-mentioned technologies simplify the tasks that the users must perform for charging, but for that reason, may unexpectedly lead to a situation where charging is not performed as intended by the users. For example, the electronic device placed on the charging stand for the purpose of charging may be removed from the charging stand due to some kind of impact, and left unattended in an incompletely charged state without the user's knowledge.

The present invention has been made in view of the above circumstances, and one of its objectives is to provide an electronic device, a control method therefor, and a program that are able to prevent a situation where charging is not performed as intended by the users.

### Solution to Problem

According to an aspect of the present invention, there is provided an electronic device including one or more processors. The processors monitor a charging status of a rechargeable battery built into the electronic device, and estimate a user's intention of charging according to the status of the electronic device. When the rechargeable battery is not being charged in a state where it is estimated that the user has the intention of charging, the processors notify the user that the rechargeable battery is not being charged.

According to yet another aspect of the present invention, there is provided a control method for controlling an electronic device. The control method includes monitoring the charging status of a rechargeable battery built into the electronic device, estimating a user's intention of charging according to the status of the electronic device, and when the rechargeable battery is not being charged in a state where it is estimated that the user has the intention of charging, notifying the user that the rechargeable battery is not being charged.

According to still another aspect of the present invention, there is provided a program that causes an electronic device to perform a process including monitoring the charging status of a rechargeable battery built into the electronic device, estimating a user's intention of charging according to the status of the electronic device, and when the rechargeable battery is not being charged in a state where it is estimated that the user has the intention of charging, notifying the user that the rechargeable battery is not being charged.

The program may be recorded and supplied on a computer-readable non-transitory information storage medium.

### BRIEF DESCRIPTION OF DRAWINGS

FIG. 1 is a configuration block diagram illustrating an overall configuration of an electronic device according to an embodiment of the present invention.

FIG. 2 is a diagram illustrating an example of how the electronic device according to the embodiment of the present invention is charged.

FIG. 3 is a functional block diagram illustrating the functions of the electronic device according to the embodiment of the present invention.

FIG. 4 is a flowchart illustrating an example of the flow of processing performed by the electronic device according to the embodiment of the present invention.

### DESCRIPTION OF EMBODIMENT

The embodiment of the present invention will now be described with reference to the accompanying drawings.

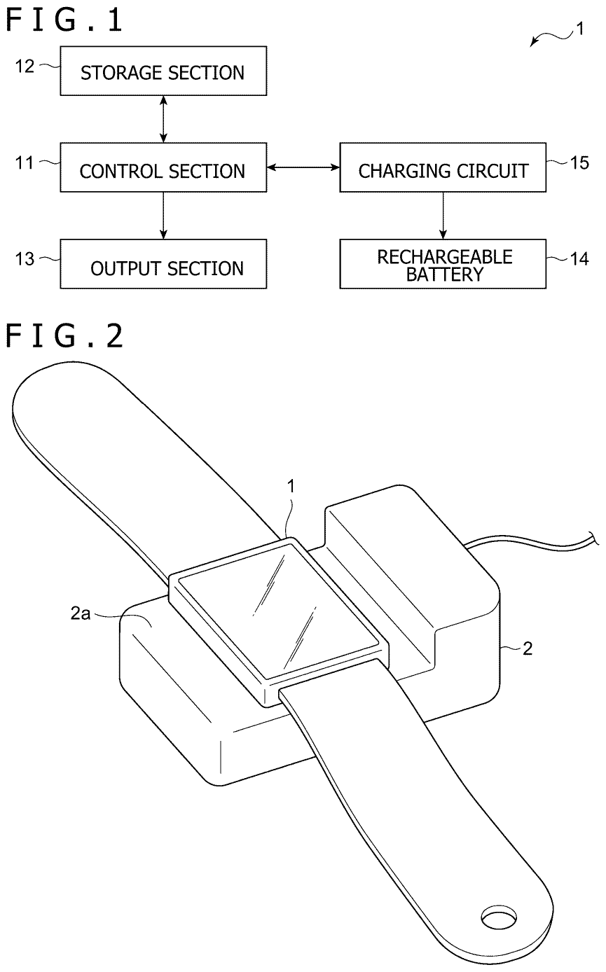

It is assumed that an electronic device 1 according to the embodiment of the present invention is a device that is used by a user while it is worn by the user, namely, a smartwatch, smart glasses, or other wearable terminal, wireless earphones, or a hearing aid. Alternatively, the electronic device 1 may be a smartphone or other device that can be carried and used by a user. As depicted in FIG. 1, the electronic device 1 includes a control section 11, a storage section 12, an output section 13, a rechargeable battery 14, and a charging circuit 15.

The control section 11 includes at least one processor, such as a central processing unit (CPU), and performs various information processing tasks by executing a program stored in the storage section 12. It should be noted that specific examples of the processing tasks performed by the control section 11 in the present embodiment will be described later. The storage section 12 includes at least one memory device such as a random access memory (RAM), and stores the program executed by the control section 11 and data processed by the program.

The output section 13 is a device that outputs information to the outside in accordance with instructions from the control section 11, and may include, for example, a speaker for producing sounds and a communication interface for transmitting information to external communication equipment.

The rechargeable battery 14 is a rechargeable battery such as a lithium-ion battery and used to supply power necessary for operating various sections of the electronic device 1. The charging circuit 15 charges the rechargeable battery 14 by using power supplied from an external power supply source.

In particular, in the present embodiment, the electronic device 1 is assumed to be compatible with a wireless charging technology. As a specific example, a charger 2 for charging the electronic device 1 includes a charging stand 2a, and it is assumed that, when charging the electronic device 1, the user places the electronic device 1 in a predetermined position and in a predetermined orientation on the charging stand 2a. When the electronic device 1 is properly placed on the charging stand 2a, the charging circuit 15 charges the rechargeable battery 14 built into the electronic device 1 by using power supplied from the charger 2. FIG. 2 is a diagram illustrating an example of how the electronic device 1 is charged, and indicates how the electronic device 1 is placed on the charging stand 2a of the charger 2 and charged in a case where the electronic device 1 is a smartwatch.

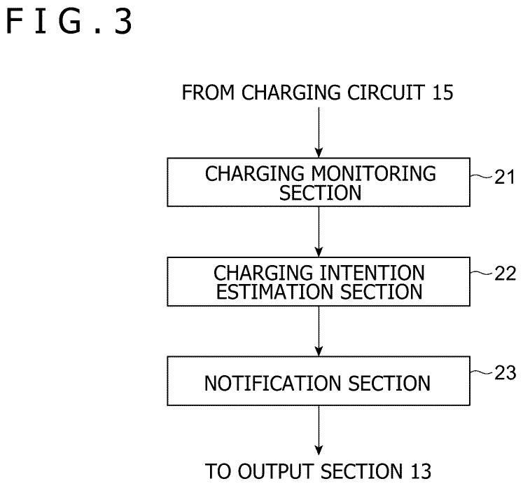

Functions implemented by the electronic device 1 according to the present embodiment will now be described with reference to FIG. 3. As depicted in FIG. 3, the electronic device 1 functionally includes a charging monitoring section 21, a charging intention estimation section 22, and a notification section 23. The functions of the above-mentioned sections are implemented when the control section 11 executes the program stored in the storage section 12. The program may be supplied to the electronic device 1 through a communication network such as the Internet, or may be recorded on an optical disk or other non-transitory information storage medium and supplied to the electronic device 1.

The charging monitoring section 21 continuously checks the operating status of the charging circuit 15 to monitor whether or not the electronic device 1 is being charged. In particular, in the present embodiment, if charging is interrupted before the rechargeable battery 14 becomes fully charged while charging is in progress, the charging monitoring section 21 detects such a situation and notifies the charging intention estimation section 22 of the detected situation.

In a case where the charging monitoring section 21 detects that charging is interrupted, the charging intention estimation section 22 estimates whether or not the user currently intends to charge the electronic device 1. If charging is interrupted even though it is estimated that the user has the intention of charging, it is conceivable that measures such as resuming charging needs to be taken because such interruption is contrary to the user's intention. Consequently, when charging is interrupted in a situation where it is estimated that the user has the intention of charging, the charging intention estimation section 22 instructs the notification section 23 to notify the user of interrupted charging. Meanwhile, in a case where it is estimated that the user has no intention of charging, the interruption of charging is considered to be based on the user's intention. In this case, therefore, the charging intention estimation section 22 determines that it is unnecessary to send the notification to the user, and thus refrains from issuing a notification instruction. It should be noted that a specific example in which the charging intention estimation section 22 provides control over the estimation of the user's intention will be described later.

In a case where the charging intention estimation section 22 detects a situation where charging is not being performed despite the user's intention, the notification section 23 notifies the user of such a fact. Various methods of notification may be used. For example, the notification section 23 may use a speaker to produce a warning sound to notify the user that charging is not being performed. Alternatively, the notification section 23 may vibrate a vibration mechanism built into the electronic device 1 to notify the user of interrupted charging, or may light or blink a predetermined indicator disposed on the surface of the electronic device 1 to notify the user of interrupted charging.

Further, the notification section 23 may transmit a control command to a device communicatively connected to the electronic device 1 so as to cause the communicatively connected device to notify the user of interrupted charging. In some cases, for example, for controlling the operation of the electronic device 1, a smartphone or other mobile information terminal is connected to the electronic device 1 in compliance with a communication standard such as Bluetooth (registered trademark). In such cases, the notification section 23 transmits the control command to the connected mobile information terminal in order to request the notification to the user. In accordance with the control command, the mobile information terminal sends the notification to the user by displaying an on-screen message or producing the warning sound from the speaker. Even in a case where, for example, the user is not in close proximity to the electronic device 1, adopting the above-mentioned methods makes it possible to notify the user of interrupted charging as long as the user carries the mobile information terminal such as a smartphone.

Specific examples in which the charging intention estimation section 22 provides control over the estimation of the user's intention of charging will now be described. As exemplified below, the charging intention estimation section 22 identifies the current status of the electronic device 1 by using, for example, various sensors in order to estimate whether or not the user has the intention of charging.

As a first example, the charging intention estimation section 22 may estimate whether or not the electronic device 1 is being used (the electronic device 1 is being used by the user). If the electronic device 1 is being used, the charging intention estimation section 22 may estimate that the user has no intention of charging.

Meanwhile, if the electronic device 1 is not being used, the charging intention estimation section 22 may estimate that the user has the intention of charging. In a case where the electronic device 1 is a wearable terminal or other device worn by the user, the charging intention estimation section 22 can detect the posture and motion of the electronic device 1 and thus estimate whether or not the electronic device 1 is worn by the user. In the present example, it is assumed that a posture sensor is incorporated in the electronic device 1. Here, the posture sensor is a sensor for detecting the posture and motion of the electronic device 1, and may include, for example, an acceleration sensor, a gyroscope, and a geomagnetic sensor. The charging intention estimation section 22 references the output of the posture sensor to determine whether or not the electronic device 1 is worn on the user's body.

If the user wears the electronic device 1 within a predetermined time after the interruption of charging, it is estimated that charging is interrupted to allow the user to use the electronic device 1, and that the interruption of charging is based on the user's intention. Therefore, the charging intention estimation section 22 determines that it is not necessary to send the notification to the user. Meanwhile, if the user does not use the electronic device 1 for a period longer than the predetermined time after the interruption of charging, the interruption may be contrary to the user's intention. Therefore, in a case where the user does not use the electronic device 1 for the predetermined time or longer after the interruption of charging, the charging intention estimation section 22 determines to send the notification to the user. This makes it possible to make the user aware of the interruption of charging.

Incidentally, here, it is assumed that whether or not the electronic device 1 is being used is estimated based on the result of detection by the posture sensor. However, the method of estimating whether or not the electronic device 1 is being used is not limited to such a method. For example, in a case where an object detection sensor for detecting a human body within a predetermined distance is disposed on the surface of the electronic device 1, the charging intention estimation section 22 may determine, based on the result of detection by the object detection sensor, whether or not the electronic device 1 is being used. In a case where the electronic device 1 is a device such as a wearable terminal, referencing the result of detection by such a sensor makes it possible to determine whether or not the electronic device 1 is worn by the user. If the electronic device 1 is not worn by the user for the predetermined time or longer while the electronic device 1 is not being charged, the charging intention estimation section 22 determines that charging may be interrupted against the user's intention.

Further, in a case where an operating member (such as a button or a touch panel) provided on the electronic device 1 is operated by the user within the predetermined time after the interruption of charging, the charging intention estimation section 22 may determine that the user has started using the electronic device 1, and may estimate that the interruption of charging is based on the user's intention.

Furthermore, in a case where the electronic device 1 is an eyeglass-type device such as smart glasses, the charging intention estimation section 22 may, if the temples of the glasses are left folded, determine that the electronic device 1 is not being used, and may, if the temples are unfolded, determine that the electronic device 1 is being used regardless of whether or not the electronic device 1 is actually worn by the user.

It should be noted that, if it is detected that charging is resumed before the predetermined time has elapsed since the interruption of charging, the charging intention estimation section 22 does not send the notification to the user. This is because charging continues without the need to estimate the intention of charging. For example, in a case where the user temporarily picks up the electronic device 1 that is being charged, and then immediately returns it to the charging stand 2a, unnecessary notification to the user can be avoided by exercising the above control.

As a second example, in a case where the main body of the electronic device 1 maintains a specific posture, the charging intention estimation section 22 may estimate the intention of charging. In the present example, as is the case with the first example, the posture of the electronic device 1 is identified based on the result of detection by the posture sensor built into the electronic device 1. Then, when the identified posture satisfies a predetermined condition, it is estimated that the user has the intention to charge the electronic device 1.

Specifically, while the electronic device 1 is stationary, the charging intention estimation section 22 determines whether or not the electronic device 1 is in a specific orientation. For example, when the user places the electronic device 1 with its surface (such as the face of a smartwatch) facing up, the charging intention estimation section 22 estimates that the user has the intention to charge the electronic device 1, and when the user places the electronic device 1 with its surface facing down, the charging intention estimation section 22 estimates that the user has no intention of charging.

When the above-described determination criteria are applied, when the user places the electronic device 1, with its surface facing up, on the charging stand 2a, it is estimated that the user has the intention of charging. Therefore, if the electronic device 1 unexpectedly moves away from the charger and remains uncharged without changing its orientation, the user can be notified of such a fact. Meanwhile, in a case where the electronic device 1 is temporarily removed by the user and placed somewhere with its surface facing down, no warning will be issued even if charging is not being performed. When the electronic device 1 is a wearable terminal such as a smartwatch, it is assumed that the user usually uses the electronic device 1 while it is worn on the user's body. Therefore, if it is estimated that the user intends to charge the electronic device 1 only when the electronic device 1 remains stationary in a specific orientation, it is possible to detect a state in which charging is not being performed despite the user's intention without excessive warnings.

It should be noted that the posture stipulating a condition for estimating the intention of charging is not limited to facing upward. The charging intention estimation section 22 may estimate that the user has the intention of charging the electronic device 1 when it remains stationary in a predetermined posture. For example, in a case where the charging stand 2a has a given angle with respect to the vertical plane while a reference angle for estimating the intention of charging is determined according to the given angle, the charging intention estimation section 22 is able to detect a state in which the electronic device 1 is not being charged even though it is placed on the charging stand 2a.

As a third example, the charging intention estimation section 22 may estimate the intention of charging according to the status of the electronic device 1 with respect to the charger 2. In the present example, it is assumed that the electronic device 1 is capable of acquiring information regarding a relation between the electronic device 1 and the charger 2.

Specifically, in a case where the electronic device 1 remains near the charger 2 even after the interruption of charging, the charging intention estimation section 22 may estimate that charging is interrupted against the user's intention while the user has the intention to charge the electronic device 1. In the present example, it is assumed that the electronic device 1 is, for example, wirelessly communicatively connected to the charger 2, and is thus capable of detecting whether or not the charger 2 is present within a predetermined distance range. In a case where the charger 2 remains within the predetermined distance range from the electronic device 1 for a predetermined time after the interruption of charging, the charging intention estimation section 22 estimates that the charging is interrupted against the user's intention.

Further, the charging intention estimation section 22 may determine, based on the result of detection by the object detection sensor disposed on the surface of the electronic device 1, whether or not a predetermined portion of the electronic device 1 is in contact with the charging stand 2a. In this case, if the electronic device 1 remains in contact with the charging stand 2a even after the interruption of charging, the charging intention estimation section 22 estimates that the charging is unintentionally interrupted.

Moreover, the charger 2 may occasionally have a built-in rechargeable battery and use the power supplied from the built-in rechargeable battery to charge the electronic device 1. For example, some wireless earphone cases have a built-in rechargeable battery, and function as a charger 2 that stores the wireless earphones and charges the stored wireless earphones. When the user stores the wireless earphones in such a case-type charger 2, it is assumed that the user intends to charge the wireless earphones. However, when the built-in rechargeable battery is low, this charger 2 is unable to charge the electronic device 1. Therefore, when the electronic device 1 is stored in the case-type charger 2, the charging intention estimation section 22 may estimate that the user intends to charge the electronic device 1, and may send the notification to the user if the charging of the electronic device 1 stored in the case-type charger 2 is interrupted.

In the case of the above example, the charging intention estimation section 22 needs to detect that the electronic device 1 is stored in the charger 2. Specifically, for example, the charging intention estimation section 22 may determine, based on the result of detection by the object detection sensor disposed on the surface of the electronic device 1, that the electronic device 1 is stored in the case-type charger 2, as is the case with the earlier example of detecting the contact with the charging stand 2a. When the object detection sensor is disposed at a position on the surface of the electronic device 1 that is not in contact with anything during normal use and is assumed to be in contact with the lid of the case when the electronic device is stored in the case and the lid is closed, the charging intention estimation section 22 is able to reference the result of detection by the object detection sensor and thus detect a state in which the electronic device 1 is stored in the charger 2 and the lid is closed. Alternatively, if the charger 2 is able to detect: its own state and notify the electronic device 1 of the result of detection by means, for example, of wireless communication, the charging intention estimation section 22 may detect, based on the notification from the charger 2, a state in which the electronic device 1 is stored in the charger 2. In this case, the charger 2 detects, for example, that the lid is closed, and that the electronic device 1 is placed in a storage space, and the like, and notifies the electronic device 1 of the result of such detection. Upon receiving such notification, the charging intention estimation section 22 is able to identify that the electronic device 1 is stored in the charger 2.

In any case, if the electronic device 1 remains stored in the charger 2 even after the interruption of charging, the charging intention estimation section 22 estimates that the user intends to continue charging, and that the interruption of charging is contrary to the user's intention. This makes it possible to notify the user of interrupted charging when, for example, the rechargeable battery built into the charger 2 is low and thus unable to charge the electronic device 1, or when the electronic device 1 is displaced even though it is stored in the charger 2.

The charging intention estimation section 22 may use a combination of the above-described determination criteria for estimating the intention of charging. Further, the charging intention estimation section 22 may combine the above-described determination criteria with other criteria to determine whether or not to send the notification to the user.

As an example, in a case where the charging is interrupted during a predetermined time period (e.g., during nighttime), the charging intention estimation section 22 may selectively determine whether or not to send the notification to the user as described above, and may not send the notification to the user even if the charging is interrupted during the other time periods.

Furthermore, in a case where the electronic device 1 is placed in a predetermined location (e.g., the user's home), the charging intention estimation section 22 may selectively determine whether or not to send the notification to the user. In this case, it is assumed that the electronic device 1 has a built-in device for acquiring the current location, such as a global positioning system (GPS) receiver. Then, if the electronic device 1 is placed in the predetermined location when the charging is interrupted, the charging intention estimation section 22 estimates the intention of charging as described above, and determines whether or not to send the notification to the user. Meanwhile, in a case where the electronic device 1 is placed in a location other than the predetermined location, the charging intention estimation section 22 neither estimates the intention of charging nor sends the notification to the user. This makes it possible to avoid unnecessary notifications.

Moreover, in addition to information regarding the current location of the electronic device 1, the charging intention estimation section 22 may acquire information regarding the current location of a predetermined communication device communicatively connected to the electronic device 1, and may determine, based on the current location of such a communication device, whether or not to send the notification to the user. For example, in a case where the electronic device 1 is connected to a smartphone and the notification section 23 is set to notify the user from the smartphone by transmitting a control command to the smartphone, the charging intention estimation section 22 acquires information regarding the current location of the smartphone when the charging is interrupted, and determines whether or not the current location indicated by the acquired information is included in a predetermined location (e.g., the user's home). Then, if the smartphone is placed in the predetermined location, the charging intention estimation section 22 determines to send the notification to the user. In this manner, it is possible to send the notification to the user only in a case where it is estimated that the user carrying the smartphone is able to immediately check the status the electronic device 1. It should be noted that the charging intention estimation section 22 may use, for example, information regarding the connection status of a wireless local area network (LAN) (e.g., service set identifier (SSID)) in order to estimate the current location of the electronic device 1 or of the communication device connected to the electronic device 1.

Additionally, in a case where the user issues an instruction to enter a charging monitoring mode, the charging intention estimation section 22 may start monitoring whether or not charging is being performed, and exercise control as described above. In this case, when the user issues an instruction to exit the charging monitoring mode, the charging intention estimation section 22 may end the monitoring of charging, and refrain from sending the notification to the user even if the charging is interrupted thereafter.

Further, if the charging is interrupted while the remaining charge of the rechargeable battery 14 is equal to or smaller than a predetermined threshold, the charging intention estimation section 22 may determine whether or not to send the notification to the user. Meanwhile, when the remaining charge of the rechargeable battery 14 is greater than the predetermined threshold, the charging intention estimation section 22 may unconditionally refrain from sending the notification to the user. This makes it possible to send the notification to the user only when there is a high possibility of the rechargeable battery running out of charge.

Alternatively, the charging intention estimation section 22 may change a notification level according to the remaining charge of the rechargeable battery 14 and/or the accuracy of the result of estimation of the intention of charging (the estimated probability of the user intending to perform charging). Specifically, in the case where, for example, the remaining charge of the rechargeable battery 14 is greater than the predetermined threshold, the charging intention estimation section 22 may lower the notification level and send a more modest notification to the user than in the case where the charging is interrupted when the remaining charge of the rechargeable battery 14 is equal to or smaller than the predetermined threshold. Alternatively, in a case where, for example, the result of detection by the posture sensor is used to estimate the user's use of the electronic device 1 and the estimated probability of the user intending to perform charging when the charging is interrupted is equal to or smaller than a predetermined threshold, the charging intention estimation section 22 may lower the notification level to a level lower than when the estimated probability is higher than the predetermined threshold (i.e., when it can be reliably estimated that the user intends to charge the electronic device 1). When a determination is made to lower the notification level, the notification section 23 may lower the volume of a notification sound, shorten the time period for notification, or reduce the number of snoozes when snooze (re-notification) is set up. This makes it possible to send a relatively modest notification to the user when the user is not estimated to be in a pressing need to address the interruption of charging or when the necessity of addressing the interruption of charging is unclear.

Furthermore, when the notification section 23 sends the notification to the user, the charging intention estimation section 22 may receive a user's response to the notification and change the conditions for sending the notification depending on the details of the response. For example, upon receiving a user's response indicating that the notification is not necessary, the charging intention estimation section 22 may refrain from sending the notification to the user until the lapse of a specified time.

Moreover, it is assumed in the above description that, when charging being performed is interrupted (i.e., when the charging status is changed from an in-progress charging state to a state where charging is not performed), the charging intention estimation section 22 determines whether or not to send the notification. However, the present invention is not limited to such a configuration. Alternatively, simply when a stopped charging state continues, the charging intention estimation section 22 may determine whether or not to send the notification.

For example, in a case where the charging is not being performed and the electronic device 1 remains in a specific posture for a predetermined time or longer, the charging intention estimation section 22 determines to send the notification to the user. In this example, when the rechargeable battery 14 is not fully charged and charging is not being performed by the charging circuit 15, the charging intention estimation section 22 continuously monitors the status of the electronic device 1 and determines whether or not the user's intention of charging can be estimated. If the user's intention of charging can be continuously estimated, the charging intention estimation section 22 sends the notification to the user. For example, in a case where the user removes the electronic device 1 worn by the user, places the electronic device 1 on the charging stand 2a with the intention of charging the electronic device 1, but charging does not start, for instance, due to misalignment, exercising the above-described control makes it possible to notify the user of such a state.

In particular, in a case where the charger 2 is of a case type that stores the electronic device 1, it is assumed that the user expects the electronic device 1 to be charged when the electronic device 1 is stored in the charger 2. However, depending on, for example, the remaining charge of the rechargeable battery built into the charger 2, the charging may not start even when the electronic device 1 is stored in the charger 2.

Therefore, upon detecting that the electronic device 1 is placed in the charger 2, the charging intention estimation section 22 monitors whether or not the charging starts before the elapse of a predetermined time. If the charging does not start, the charging intention estimation section 22 may estimate that the charging is not performed despite the user's intention, and send the notification to the user.

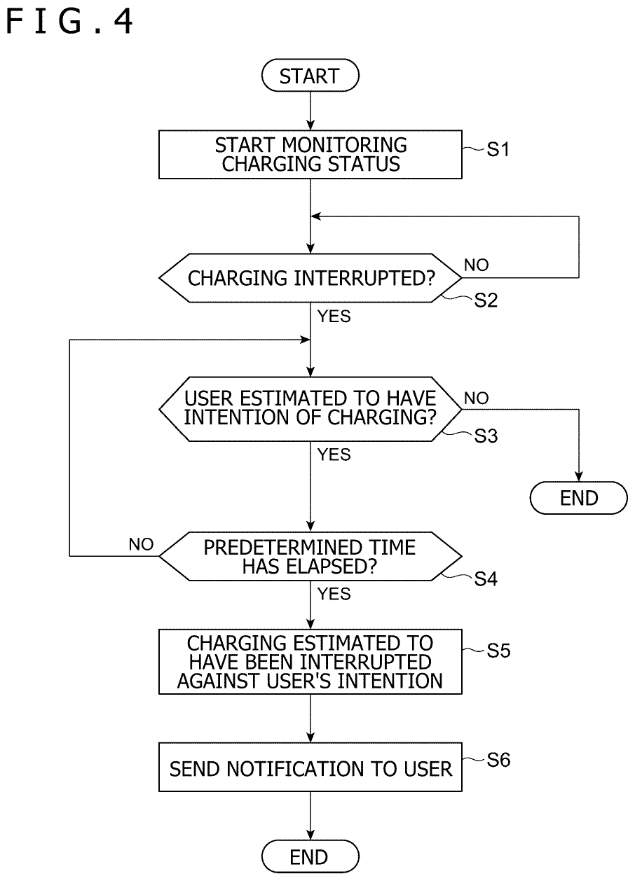

Here, an example of the flow of processing performed by the electronic device 1 will now be described with reference to the flowchart of FIG. 4. In this example, it is assumed that control for detecting the above-described interruption of charging is exercised at the timing when the charging is started by the charging circuit 15.

When the charging is started by the charging circuit 15, the charging monitoring section 21 first starts monitoring the charging status (S1). Then, upon detecting the interruption of charging before the rechargeable battery 14 is fully charged, the charging monitoring section 21 notifies the charging intention estimation section 22 of such a fact (S2).

The charging intention estimation section 22 determines, based on the status of the electronic device 1, whether or not the user intends to charge the electronic device 1 (S3). As a specific example, the electronic device 1 determines, based on the result of detection by the posture sensor, whether or not the electronic device 1 is worn by the user. Then, if the electronic device 1 is worn by the user, it is presumably estimated that the user intends to end the charging. Meanwhile, if the electronic device 1 is not worn by the user, it is presumably estimated that the user still intends to continue charging.

If it is estimated in S3 that the electronic device 1 is worn by the user (i.e., the user does not intend to continue charging), the charging intention estimation section 22 ends the processing. Meanwhile, if the electronic device 1 is not worn by the user, the charging intention estimation section 22 repeats S3 until such a state continues for a predetermined time, and thus determines whether or not the user intends to charge the electronic device 1 (S4). That is, the charging intention estimation section 22 repeatedly makes the determination in S3 at relatively short time intervals over the predetermined time.

If the predetermined time has passed without the user wearing the electronic device 1, the charging intention estimation section 22 estimates that the interruption of charging in S2 was contrary to the user's intention (S5). Then, the charging intention estimation section 22 instructs the notification section 23 to notify the user of interrupted charging in a predetermined manner. Upon receiving such an instruction, the notification section 23 produces the warning sound from the speaker or takes other appropriate measures to notify the user of interrupted charging (S6).

When the above-described control is exercised, the electronic device 1 according to the embodiment of the present invention is able to prompt the user to resume charging by notifying the user of interrupted charging.

Further, by determining, based on the result of estimation of the user's intention of charging, whether or not to send the notification to the user, it is possible to send the notification to the user only when the charging is not being performed despite the user's intention. This reduces the possibility of occurrence of unnecessary notifications.

It should be noted that the present invention is not limited to the above-described embodiment. For example, the above description mainly deals with a specific example in which the electronic device 1 is a device worn by the user, such as a smartwatch or smart glasses.

However, the electronic device 1 is not limited to such devices, and may be various devices that operate on power supplied from the built-in rechargeable battery 14.

Furthermore, the method for charging the electronic device 1 by using the charger 2 is not limited to wireless charging, and may alternatively be a charging method in which, for example, the electronic device 1 is in contact with a charging terminal provided on the charger 2.

Moreover, the determination criteria by which the charging intention estimation section 22 estimates the user's intention of charging are not limited to those described above, and may include various conditions related to the status of the electronic device 1 and the status of the charger 2. Additionally, whether or not the user intends to charge the electronic device 1 may be determined based on an appropriate combination of such various conditions.

### REFERENCE SIGNS LIST

1: Electronic device
2: Charger
2a: Charging stand
11: Control section
12: Storage section
13: Output section
14: Rechargeable battery
15: Charging circuit
21: Charging monitoring section
22: Charging intention estimation section
23: Notification section

1.-12. (Canceled)

13. A method comprising:
determining, by one or more processors, whether a charging operation for a battery of an electronic device is interrupted;
responsive to determining the charging operation is interrupted, determining a user intent to continue charging the battery by the one or more processors; and
responsive to determining the user intent, initiating notification of the interruption to the user.

14. The method of claim 13, wherein determining the user intent comprises:
detecting one or more of a position and orientation of the electronic device.

15. The method of claim 14, wherein determining the user intent further comprises:
identifying a charging device for the electronic device; and
determining a distance between the charging device and the electronic device is below a predetermined threshold.

16. The method of claim 14, wherein determining the user intent further comprises:
identifying a charging device for the electronic device; and
detecting that at least a portion of the electronic device contacts a surface of the charging device.

17. The method of claim 16, wherein detecting that at least a portion of the electronic device contacts a surface of the charging device comprises detecting that the electronic device is received within the charging device.

18. The method of claim 13, further comprising:
determining the user is using the electronic device; and
responsive to determining use, suppressing notification of the interruption to the user.

19. The method of claim 18, wherein determining the user is using the electronic device comprises one or more of:
determining the user is wearing the electronic device;
receiving user input to the electronic device; and
detecting user manipulation of the electronic device.

20. An electronic device comprising:
a battery; and
one or more processors configured to perform operations comprising:
determining, by the one or more processors, whether a charging operation for the battery is interrupted;
responsive to determining the charging operation is interrupted, determining a user intent to continue charging the battery by the one or more processors; and
responsive to determining the user intent, initiating notification of the interruption to the user.

21. The electronic device of claim 20, wherein determining the user intent comprises: detecting one or more of a position and orientation of the electronic device.

22. The electronic device of claim 21, wherein determining the user intent further comprises:
identifying a charging device for the electronic device; and
determining a distance between the charging device and the electronic device is below a predetermined threshold.

23. The electronic device of claim 21, wherein determining the user intent further comprises:
identifying a charging device for the electronic device; and
detecting that at least a portion of the electronic device contacts a surface of the charging device.

24. The electronic device of claim 23, wherein detecting that at least a portion of the electronic device contacts a surface of the charging device comprises detecting that the electronic device is received within the charging device.

25. The electronic device of claim 20, wherein the operations further comprise:
determining the user is using the electronic device; and
responsive to determining use, suppressing notification of the interruption to the user.

26. The electronic device of claim 25, wherein determining the user is using the electronic device comprises one or more of:
determining the user is wearing the electronic device;
receiving user input to the electronic device; and
detecting user manipulation of the electronic device.

27. One or more computer storage media encoded with instructions that, when executed by one or more processors, cause the one or more processors to perform operations comprising:
determining, by the one or more processors, whether a charging operation for a battery of the electronic device is interrupted;
responsive to determining the charging operation is interrupted, determining a user intent to continue charging the battery by the one or more processors; and
responsive to determining the user intent, initiating notification of the interruption to the user.

28. The one or more computer storage media of claim 27, wherein determining the user intent comprises: detecting one or more of a position and orientation of the electronic device.

29. The one or more computer storage media of claim 28, wherein determining the user intent further comprises:
identifying a charging device for the electronic device; and
determining a distance between the charging device and the electronic device is below a predetermined threshold.

30. The one or more computer storage media of claim 28, wherein determining the user intent further comprises:
identifying a charging device for the electronic device; and
detecting that at least a portion of the electronic device contacts a surface of the charging device.

31. The one or more computer storage media of claim 27, wherein the instructions further cause the one or more processors to perform operations comprising:
determining the user is using the electronic device; and
responsive to determining use, suppressing notification of the interruption to the user.

32. The one or more computer storage media of claim 31, wherein determining the user is using the electronic device comprises one or more of:
determining the user is wearing the electronic device;
receiving user input to the electronic device; and
detecting user manipulation of the electronic device.
